(19) United States
(12) Patent Application Publication
(10) Pub. No.: US 2018/0363371 A1
(43) Pub. Date: Dec. 20, 2018

(54) ADJUSTABLE LADDER DEVICE AND METHOD

(71) Applicant: Thomas Huckabay, Rusk, TX (US)

(72) Inventor: Thomas Huckabay, Rusk, TX (US)

(21) Appl. No.: 16/013,826

(22) Filed: Jun. 20, 2018

Related U.S. Application Data
(60) Provisional application No. 62/522,240, filed on Jun. 20, 2017.

(51) Int. Cl. E06C 1/12; E06C 7/42; E06C 7/48; E06C 7/50

(52) U.S. Cl. CPC E06C 1/125; E06C 7/50; E06C 7/48; E06C 7/423

(57) ABSTRACT

An adjustable ladder includes a first elongate member, a second elongate member being positioned in a parallel relationship to the first elongate member, a plurality of rungs extending from the first elongate member to the second elongate member, a plurality of extensions coupled to a distal end of the adjustable ladder via a plurality of hinges, and a plurality of stabilizers located at a proximal end of the adjustable ladder. The adjustable ladder is useful for providing increased stability in hard to reach areas.

### CROSS-REFERENCE TO RELATED APPLICATION(S)

The present application is related to and claims priority to U.S. Provisional Patent Application No. 62/522,240 filed Jun. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of ladders of existing art and more specifically relates to ladder supports.

### RELATED ART

Many people use ladders to reach places that are too high for someone to reach with out aid. A ladder is a vertical or inclined set of rungs or steps. They are commonly made of metal, wood, or fiberglass, and they have also been known to be made of tough plastic. When a full-size ladder is not necessary, a step stool may be used.

When using a conventional ladder, workers must place the ladder against the house and reach backwards to access eaves and fascia boards. This is not only uncomfortable, but also poses a safety risk to the individual. When trying to access the eaves, plants and planters may be damaged in the process. Interior locations, such as above free-standing cabinets, are difficult, if not impossible, to access without unloading and moving. An effective alternative is needed.

U.S. Pat. No. 5,165,501 to Howard E. Donahey relates to a ladder support attachment. The described ladder support attachment includes a multiple use ladder support attachment (M.U.L.S.A.), for hollow rung ladders, designed to pivot and lock a pair of arms (with a support plate across one end) so as to offset and support a ladder top from a roof of any slope (pitch) or to pivot the support plate upward and support the ladder top a selectable distance from a vertical wall or to further pivot upward and place the support plate between the ladders rail tops and any fragile siding to protect the siding from damage. A pair of adjustable length pivotal upper arms connected to a pair of adjustable length pivotal lower arms. The upper arms control the distance from ladder to support plate while the lower arms control the angle of the upper arms (and support plate). The pivotal action allows a simple change from one support position to another.

### SUMMARY OF THE INVENTION

In view of the foregoing disadvantages inherent in the known ladder supports art, the present disclosure provides a novel adjustable ladder device and method. The general purpose of the present disclosure, which will be described subsequently in greater detail, is to provide an adjustable ladder with an arm that allows users to safely access hard to reach places.

An adjustable ladder is disclosed herein. The adjustable ladder may include a first elongate member, a second elongate member being positioned in a parallel relationship to the first elongate member, a plurality of rungs extending from the first elongate member to the second elongate member, a plurality of extensions coupled to a distal end of the adjustable ladder via a plurality of hinges, and a plurality of stabilizers located at a proximal end of the adjustable ladder. The adjustable ladder may be useful for providing increased stability in hard to reach areas.

According to another embodiment, a method of using an adjustable ladder is also disclosed herein. The method of using an adjustable ladder includes providing an adjustable ladder device, placing the adjustable ladder in a desired work area, and adjusting the plurality of extensions to a desired configuration.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an adjustable ladder device and method, constructed and operative according to the teachings of the present disclosure.

FIG. 1 is a perspective view of the adjustable ladder during an ‘in-use’ condition, according to an embodiment of the disclosure.

FIG. 2 is a side perspective view of the adjustable ladder of FIG. 1, according to an embodiment of the present disclosure.

FIG. 3 is an alternate perspective view of the adjustable ladder of FIG. 1, according to an embodiment of the present disclosure.

FIG. 4 is a close-up perspective view of the adjustable ladder of FIG. 1, according to an embodiment of the present disclosure.

FIG. 5 is a flow diagram illustrating a method of using an adjustable ladder, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a ladder support and more particularly to an adjustable ladder device and method as used to provide an adjustable ladder with an arm that allows users to safely access hard to reach places.

Generally, the present invention provides an adjustable ladder with an arm that may allow users to safely access hard to reach places. This device may allow workers to access difficult areas, such as eaves and fascia boards when hedges are in the way, or the area above cabinets and shelves inside a home. This device may further eliminate unsafe reaching and over-extending that occurs when attempting to access areas that need work. The ladder device may also prevent or reduce uncomfortable bending and back discomfort caused by straining and reaching. The present invention offers increased stability while placing the user in a comfortable and convenient position to work on difficult to reach areas

The adjustable ladder device again may allow for safer access to hard to reach areas, such the eaves of houses, the area over kitchen cabinets, and more. The invention may include a height expandable ladder assembly having adjustable arm extensions coupled to the distal end. The adjustable arm extensions may allow the user to safely position the device over or around obstructions while working. The extensions may have multiple positions and may be positioned via hinges. These extensions may also be rested onto a flat surface for additional support. The ladder may be expandable from approximately 6′ to 8′ in height, while the adjustable arm extensions may be independently adjustable up to 18″ away from the ladder assembly. The ladder may include rectangular rungs, articulating hinges, and extensions locks.

Upon reading this specification, it should be appreciated that, under appropriate circumstances, considering such issues as user preferences, design preference, structural requirements, marketing preferences, cost, available materials, technological advances, etc., other ladder arrangements such as, for example, rung shapes, spacing, or exact measurements, etc., may be sufficient.

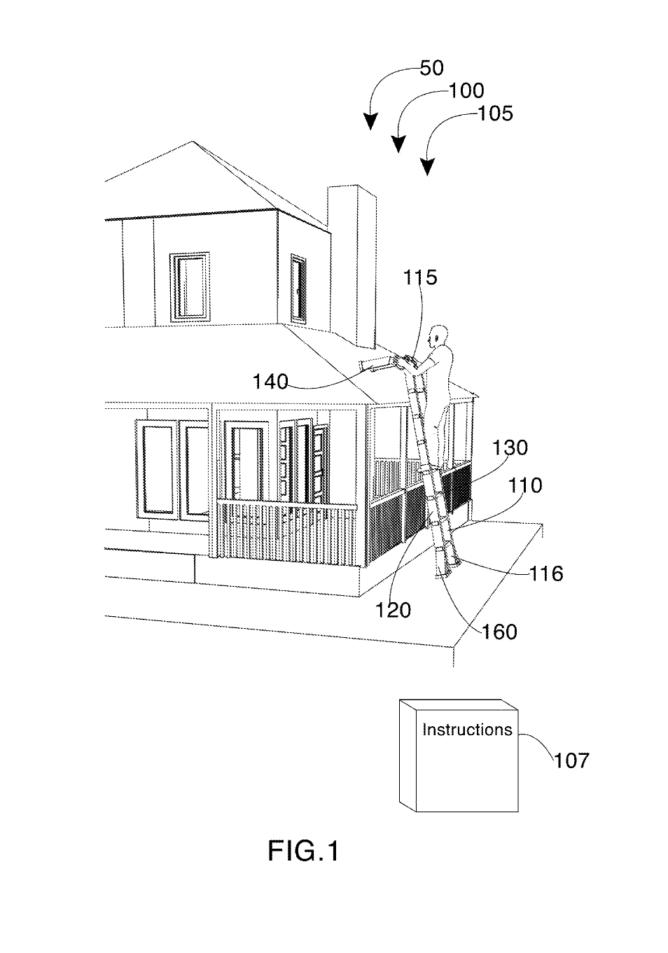

Referring now more specifically to the drawings by numerals of reference, there is shown in FIGS. 1-4, various views of an adjustable ladder 100.

FIG. 1 shows an adjustable ladder 100 during an ‘in-use’ condition 50, according to an embodiment of the present disclosure. Here, the adjustable ladder 100 may be beneficial for use by a user 40 to provide an adjustable ladder 100 with an arm that allows users to safely access hard to reach places. As illustrated, the adjustable ladder 100 may include a first elongate member 110, a second elongate member 120, the second elongate member 120 being positioned in a parallel relationship to the first elongate member 110, a plurality of rungs 130, and a plurality of extensions 140. The plurality of extensions 140 may be coupled to a distal end 115 of the adjustable ladder 100. The adjustable ladder 100 may also include a plurality of stabilizers 160 that may be located at a proximal end 116 of the adjustable ladder 100.

According to one embodiment, the adjustable ladder 100 may be arranged as a kit 105. In particular, the adjustable ladder 100 may further include a set of instructions 107. The instructions 107 may detail functional relationships in relation to the structure of the adjustable ladder 100 such that the adjustable ladder 100 can be used, maintained, or the like, in a preferred manner.

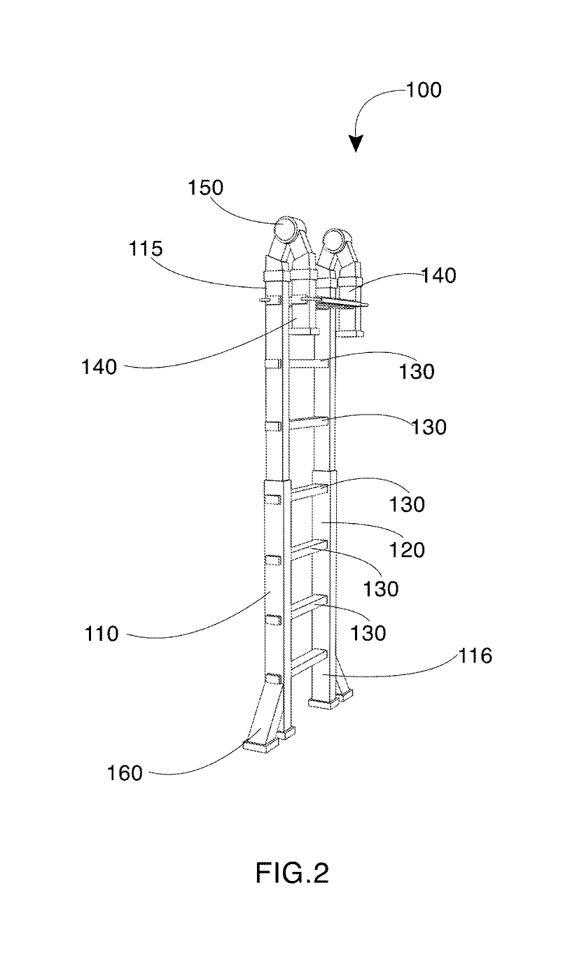

FIG. 2 shows the adjustable ladder 100 of FIG. 1, according to an embodiment of the present disclosure. As above, the adjustable ladder 100 may include a first elongate member 110, a second elongate member 120, a plurality of rungs 130, and a plurality of extensions 140. The plurality of extensions 140 may be coupled to a distal end 115 of the adjustable ladder 100. The plurality of extensions 140 may be coupled to the distal end 115 of the adjustable ladder 100 via a plurality of hinges 150. The adjustable ladder 100 may also include a plurality of stabilizers 160 that may be located at a proximal end 116 of the adjustable ladder 100.

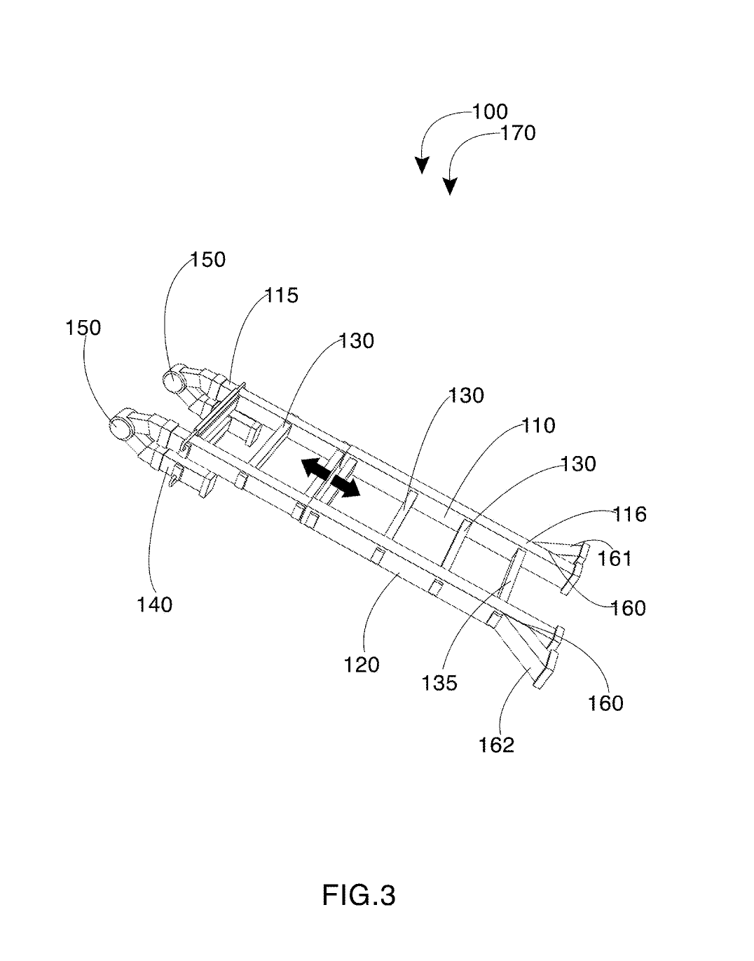

Referring now to FIG. 3, an alternative perspective view of the adjustable ladder 100 of FIG. 1, according to an embodiment of the present disclosure. Here again, the adjustable ladder 100 may include a first elongate member 110, a second elongate member 120, a plurality of rungs 130, and a plurality of extensions 140. The plurality of extensions 140 may be coupled to a distal end 115 of the adjustable ladder 100. In this embodiment, the adjustable ladder 100 may be configured as height expandable ladder 170. The plurality of extensions 140 may be coupled to the distal end 115 of the adjustable ladder 100 via a plurality of hinges 150. The adjustable ladder 100 may also include a plurality of stabilizers 160 that may be located at a proximal end 116 of the adjustable ladder 100. The plurality of stabilizers 160 may comprise a first stabilizer 161 and a second stabilizer 162 that extend from a bottom rung 135 of the adjustable ladder 100.

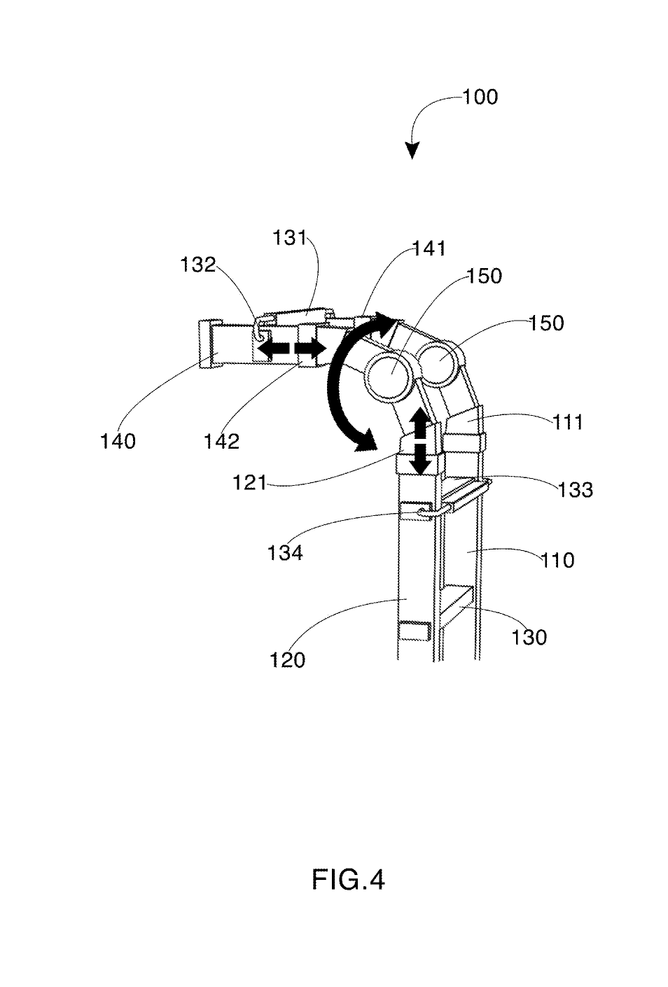

FIG. 4 is a close-up perspective view of the adjustable ladder 100 of FIG. 1, according to an embodiment of the present disclosure. As above, the adjustable ladder 100 may include a first elongate member 110, a second elongate member 120, a plurality of rungs 130, and a plurality of extensions 140. The first elongate member 110 may include a first-elongate-member-aperture 111 and the second elongate member 120 may include a second-elongate-member-aperture 121. The plurality of extensions 140 may be coupled to the adjustable ladder 100 via a plurality of hinges 150. The plurality of extensions 140 may include a first-extension-aperture 141 and a second-extension-aperture 142. The adjustable ladder 100 may additionally feature a first rung 131 that includes a first-rung-plurality-of-latching-members 132 and a second rung 133 that includes a second-rung-plurality-of-latching-members 134. The first-rung-plurality-of-latching-members 132 and the second-rung-plurality-of-latching-members 134 may be configured to lock the adjustable ladder 100 in a desired configuration.

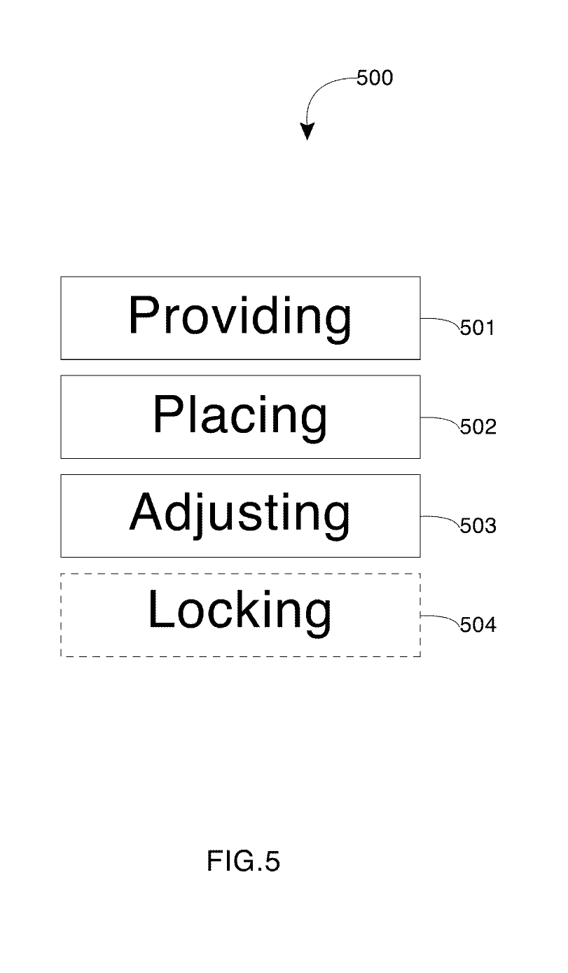

FIG. 5 is a flow diagram illustrating a method of using 500 an adjustable ladder 100, according to an embodiment of the present disclosure. In particular, the method of using 500 an adjustable ladder 100 may include one or more components or features of the adjustable ladder 100 as described above. As illustrated, the method of using 500 an adjustable ladder 100 may include the steps of: step one 501, providing a first elongate member, a second elongate member, the second elongate member being positioned in a parallel relationship to the first elongate member, a plurality of rungs, the plurality of rungs extending from the first elongate member to the second elongate member, a plurality of extensions, the plurality of extensions coupled to a distal end of the adjustable ladder via a plurality of hinges, a plurality of stabilizers, the plurality of stabilizers located at a proximal end of the adjustable ladder; step two 502, placing the adjustable ladder in a desired work area; and step three 503, adjusting the plurality of extensions to a desired configuration.

It should be noted that step four 504, locking the adjustable ladder in the desired configuration by using a latching mechanism, is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the adjustable ladder 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An adjustable ladder, comprising:
a first elongate member;
a second elongate member, the second elongate member being positioned in a parallel relationship to the first elongate member;
a plurality of rungs, the plurality of rungs extending from the first elongate member to the second elongate member;
a plurality of extensions, the plurality of extensions coupled to a distal end of the adjustable ladder via a plurality of hinges;
a plurality of stabilizers, the plurality of stabilizers located at a proximal end of the adjustable ladder; and
wherein the adjustable ladder is configured to allow a user to safely access a work area.

2. The adjustable ladder of claim 1, wherein the adjustable ladder is a height expandable ladder.

3. The adjustable ladder of claim 1, wherein the plurality of extensions comprises two extensions.

4. The adjustable ladder of claim 1, wherein the plurality of hinges comprises two hinges.

5. The adjustable ladder of claim 1, wherein the first elongate member and the second elongate member are substantially equal in length.

6. The adjustable ladder of claim 1, wherein the plurality of rungs comprises at least two rungs.

7. The adjustable ladder of claim 1, wherein the plurality of stabilizers comprises a first stabilizer and a second stabilizer.

8. The adjustable ladder of claim 7, wherein the first stabilizer and the second stabilizer extend from a bottom rung of the adjustable ladder.

9. The adjustable ladder of claim 1, wherein each of the plurality of rungs is equally spaced apart from one another.

10. The adjustable ladder of claim 1, wherein the adjustable ladder is configured to expand in height from approximately six feet to approximately eight feet.

11. The adjustable ladder of claim 1, wherein the plurality of extensions is configured to expand up to approximately 18 inches from the distal end of the adjustable ladder.

12. The adjustable ladder of claim 1, wherein a first rung includes a first-rung-plurality-of latching-members and a second rung includes a second-rung-plurality-of-latching-members, the first-rung-plurality-of-latching-members and the second-rung-plurality-of-latching-members configured to lock the adjustable ladder in a desired configuration.

13. The adjustable ladder of claim 12, wherein the first elongate member includes a first-elongate-member-aperture and the second elongate member includes a second-elongate-member-aperture.

14. The adjustable ladder of claim 1, wherein a first of the plurality of extensions includes a first-extension-aperture and a second of the plurality of extensions includes a second-extension-aperture.

15. The adjustable ladder of claim 14, wherein the second-rung-plurality of latching members is removably coupled to the first-elongate-member-aperture and the second-elongate-member-aperture and wherein the first-rung-plurality-of-latching-members is coupled to the first-extension-aperture and the second-extension-aperture.

16. The adjustable ladder of claim 1, wherein the adjustable ladder is made of a material selected from the group consisting of metal, wood, fiberglass, and rigid plastic.

17. An adjustable ladder, comprising:
a first elongate member;
a second elongate member, the second elongate member being positioned in a parallel relationship to the first elongate member;
a plurality of rungs, the plurality of rungs extending from the first elongate member to the second elongate member;
a plurality of extensions, the plurality of extensions coupled to a distal end of the adjustable ladder via a plurality of hinges;
a plurality of stabilizers, the plurality of stabilizers located at a proximal end of the adjustable ladder;
wherein the adjustable ladder is a height expandable ladder;
wherein the plurality of extensions comprises two extensions;
wherein the plurality of hinges comprises two hinges;
wherein the first elongate member and the second elongate member are substantially equal in length;
wherein the plurality of rungs comprises at least two rungs;
wherein the plurality of stabilizers comprises a first stabilizer and a second stabilizer;
wherein the first stabilizer and the second stabilizer extend from a bottom rung of the adjustable ladder;
wherein each of the plurality of rungs is equally spaced apart from one another;
wherein the adjustable ladder is configured to expand in height from approximately six feet to approximately eight feet;
wherein the plurality of extensions is configured to expand up to approximately 18 inches from the distal end of the adjustable ladder;
wherein a first rung includes a first-rung-plurality-of-latching-members and a second rung includes a second-rung-plurality-of-latching-members, the first-rung-plurality-of-latching-members and the second-rung-plurality-of-latching-members configured to lock the adjustable ladder in a desired configuration;
wherein the first elongate member includes a first-elongate-member-aperture and the second elongate member includes a second-elongate-member-aperture;
wherein a first of the plurality of extensions includes a first-extension-aperture and a second of the plurality of extensions includes a second-extension-aperture;
wherein the second-rung-plurality of latching members is removably coupled to the first-elongate-member-aperture and the second-elongate-member-aperture and wherein the first-rung-plurality-of-latching-members is coupled to the first-extension-aperture and the second-extension-aperture;
wherein the adjustable ladder is made of a material selected from the group consisting of metal, wood, fiberglass, and rigid plastic; and
wherein the adjustable ladder is configured to allow a user to safely access a work area.

18. The adjustable ladder of claim 17, further comprising set of instructions; and
wherein the adjustable ladder is arranged as a kit.

19. A method of using an adjustable ladder, the method comprising the steps of:
providing a first elongate member, a second elongate member, the second elongate member being positioned in a parallel relationship to the first elongate member, a plurality of rungs, the plurality of rungs extending from the first elongate member to the second elongate member, a plurality of extensions, the plurality of extensions coupled to a distal end of the adjustable ladder via a plurality of hinges, a plurality of stabilizers, the plurality of stabilizers located at a proximal end of the adjustable ladder;
placing the adjustable ladder in a desired work area; and
adjusting the plurality of extensions to a desired configuration.

20. The method of claim 19, further comprising the steps of:
locking the adjustable ladder in the desired configuration by using a latching mechanism.
